(19) United States
(12) Patent Application Publication
(10) Pub. No.: US 2026/0327747 A1
(43) Pub. Date: Oct. 22, 2026

(54) OXIDATIVE NITRATE HEAP LEACHING PROCESS

(71) Applicant: BHP CHILE INC, Santiago (CL)

(72) Inventor: Clement Chilowa Chibwana, Antofagasta (CL)

(73) Assignee: BHP CHILE INC, Santiago (CL)

(21) Appl. No.: 19/111,083

(22) PCT Filed: Sep. 13, 2023
(86) PCT No.: PCT/IB2023/059066

§ 371 Date: Mar. 12, 2025

(30) Foreign Application Priority Data
Sep. 16, 2022 (ZA) 2022/10270

(51) Int. Cl. C22B 15/00; C22B 1/16; C22B 3/06; C22B 3/22; C22B 3/44

(52) U.S. Cl. CPC C22B 15/0073; C22B 1/16; C22B 3/065; C22B 3/22; C22B 3/44

(57) ABSTRACT

A method of extracting copper from a sulfide mineral ore including the steps of stacking the ore to form a heap, in a leach step, irrigating the heap with a first irrigation solution containing an acid nitrate solution and nitrite thereby to cause oxidation of sulfide minerals within the heap, oxidising nitric oxide gas released during the oxidation of the sulfide minerals within the heap by oxygen to form nitrogen dioxide, and hydrolysing the nitrogen dioxide to form nitric acid and/or nitrous acid in the first irrigation solution within the heap, to continue the leach step and to reduce the loss of nitric oxide from the heap.

### BACKGROUND OF THE INVENTION

This invention relates generally to a process of leaching base metals from a heap of ore. The invention is particularly suitable for the treatment of primary copper ores containing chalcopyrite and secondary sulfide minerals e.g. enargite, bornite, chalcocite and covellite in an oxidative environment.

The oxidative action of nitrate and nitrite in aqueous solutions of sulfuric acid are extensively described in the literature and patent prior art.

Anderson (2003) states that the addition or presence of NO₂⁻ instead of NO₃⁻ enhances the reaction rates of chalcopyrite oxidation. Results presented by Gok and Anderson (2013) demonstrate that effective leaching of chalcopyrite is achieved by leaching fine milled mineral (d80 15 microns) with 0.1M NaNO₂, 1M H₂SO₄, at a temperature of over 100° C. (110-120° C.). It was found that the use of sodium nitrite, under these extreme conditions, was more effective than sodium nitrate.

Sokić et al (2009) describe the kinetics of chalcopyrite leaching in sulfuric acid solutions using sodium nitrate as the oxidant. The results indicate the importance of temperature and the requirement of fine milling to achieve satisfactory copper dissolution. It was found that the dissolution of copper increased with increasing sulfuric acid and sodium nitrate concentrations and decreasing particle size.

Baldwin and Van Weert (1996), compare the rate of oxidation of ferrous to ferric in the presence and absence of nitrates or nitrites. The rate of Fe(II) oxidation was increased by the addition of nitric acid and nitrate and was significantly increased by the addition of nitrite. Thus, adoption of nitrite-assisted oxidation in autoclaves used for mineral processing could result in more efficient operations.

Ricardo Andres Soto Mellado (Ibáñez & Mellado, 2018) describes a process of copper sulfide mineral oxidation and leaching in acid chloride and sulfuric acid chloride/nitrate solutions. The publication discloses the treatment of a low-grade copper sulfide ore in an acid chloride-nitrate medium. The concept of pre-treating ore in an agglomeration step followed by a curing step is disclosed. Mechanisms for chalcopyrite leaching in acid ferric sulfate and sulfuric acid and chloride solutions, and the action of adding nitrate (as sodium nitrate or ferric nitrate) to increase the solution oxidation potential are disclosed. Metal dissolution of 27% on a milled sample at 25% solid content on a specific low-grade ore (0.12% Cu) was achieved. Ibáñez & Mellado concluded that despite increased mineral degradation, the addition of sodium nitrate and ferric nitrate in conjunction with sodium chloride and sulfuric acid during the pre-treatment of a copper sulfide mineral does not significantly affect the final copper dissolution.

U.S. Pat. No. 9,683,277 discloses nitrate assisted leaching using ferric nitrate. The action of ferric nitrate and the method of generation of this reagent are disclosed.

WO 2012/162851, WO 2017/063099, U.S. Pat. No. 9,683,277, and CL 43295 each disclose a method of heap leaching in which either ferric nitrate, ammonium nitrate or sodium nitrate act as an oxidising agent, in a sulfuric acid or sulfuric acid/chloride aqueous solution.

U.S. Pat. No. 5,096,486 describes a sulfuric acid leach process using sodium nitrite to treat sulfide materials (including copper sulfides) by leaching under relatively mild oxygen pressure and temperature conditions.

U.S. Pat. No. 3,888,748 describes a leaching process using nitric acid and sulfuric acid at temperatures of at least 50° C., demonstrating the oxidation advantage of adding nitric acid (or nitrate) in a sulfuric acid leach.

U.S. Pat. No. 4,647,307 discloses a process for the hydrometallurgical recovery of precious metal from an ore or concentrate containing at least some arsenopyrite or pyrite. The process comprises forming in a common volume space a gas phase and a liquid slurry comprising the ore or concentrate as the solid phase and acid and water as the liquid phase of the slurry, effecting in the slurry an oxidation-reduction reaction between the arsenopyrite or pyrite and an oxidized nitrogen species in which the nitrogen has a valence of at least plus 3 thereby solubilizing in the liquid phase the arsenic, iron and sulphur in the arsenopyrite, or the iron and sulphur in the pyrite, and producing in the liquid phase nitric oxide in which the nitrogen has a valence of plus 2; releasing at least part of the nitric oxide from the liquid phase into the gas phase, oxidizing the nitric oxide in the gas phase, to form an oxidized nitrogen species in which the nitrogen has a valence of at least plus 3; and absorbing the oxidized nitrogen species into the slurry wherein the oxidized nitrogen species become available for the oxidation-reduction reaction. The resultant treated slurry is subjected to a solid-liquid separation to produce a solid residue and a liquid fraction. Precious metal is recovered from the solid residue. The liquid fraction is recycled in the process.

The process disclosed in U.S. Pat. No. 4,647,307 requires operation at a partial pressure of oxygen above the ambient partial pressure of oxygen in air. The process describes treatment of milled concentrate or ore in a slurry using a pressurised vessel (autoclave) at temperatures of 60° C. to 180° C.

WO 2021/186376 A1 describes an oxidative bioleaching process for leaching a base metal from an are that includes an ore agglomeration step, an ore stacking step wherein agglomerated ore is stacked to form a heap, a curing step, a rinse step, an inoculation step and a leach step, and wherein, during the ore agglomeration step, the ore is contacted with an acid solution containing nitrate and nitrite thereby to accelerate the leaching rate in the leach step. A further aim of the invention is to provide a bio-heap leaching process using a nitrogen compound as an oxidant wherein the inoculation and bioleaching steps are not adversely affected due to inhibiting effect of nitrate compounds on microbial growth. The method is limited by the need to include an ore agglomeration and curing step.

While effective to a limited extent, bioleaching processes often have slow reaction rates, and the initial heat generation is slow. Consequently, bioleaching methods are not effective for the treatment of ROM ore.

The prior art methods show that nitrate in an acid medium provides an option for leaching of sulfide minerals at an acceptable kinetic rate. However, these applications involve high temperatures and high levels of pressure. Additionally, the prior art methods show that agglomeration and curing steps are necessary to create reactive conditions in a heap leach environment thereby achieving relatively high acid and nitrate conditions in an almost closed system resulting in active oxidation conditions.

In nitrate leaching operations, NOₓ (NO and NO₂) gases leave the system in the leach cycle and ore agglomeration steps and result in high nitrate and acid consumption rates in the heap leach stage. To the applicant's knowledge, direct nitrate leaching with capture of NOₓ gases has only been achieved commercially in a closed system under conditions of elevated pressures, or by use of gas capture and scrubbing steps in the ore agglomeration stage prior to heap construction (as part of the ore agglomerator design).

NOₓ gases, principally as NO (low solubility in aqueous solution), leaving the surface of the heap during the leach cycle are difficult to capture and overall nitrate consumption remains high, in the range 10-20 kg/T or above 20 kg/T. Efficient recycle of NO and NO₂ gas has not been demonstrated in a heap leach process operating at ambient pressures.

A method of heap leaching for un-agglomerated crushed or ROM ore where the generation of heat through pyrite oxidation is critical to copper recovery has not been described. Crushing and agglomeration of low-grade ores significantly increase capital and operating costs.

The invention aims, at least partly, to address the aforementioned issues.

### SUMMARY OF INVENTION

“Heap” as used in herein includes treating ore in an irrigated heap, in a column, in a large vat or in a large ore dump.

All solution potential values described herein are mV versus standard hydrogen electrode (SHE).

The invention provides a method of extracting copper from a sulfide mineral ore selected from ROM ore, crushed ore or crushed ore subject to acid agglomeration, including the steps of:
a) stacking the ore to form a heap;
b) in a leach step, irrigating the heap with a first irrigation solution containing an acid nitrate (NO₃⁻) solution, and nitrite (NO₂⁻) at a concentration of between 50-500 ppm thereby to cause the oxidation of sulfide minerals within the heap;
c) adding air or oxygen, or oxygen enriched air into the heap;
d) oxidising NO gas released during the oxidation of the sulfide minerals within the heap by oxygen to form nitrogen dioxide (NO₂); and
e) hydrolysing the nitrogen dioxide (NO₂) to form nitric acid and/or nitrous acid in the solution within the heap, to continue the leaching step.

Recycling the nitric acid and/or nitrous acid produced within the heap in step (e) for use in the first irrigation solution reduces the loss of NO gas from the heap to between 5%-30%.

The method may include the step of capturing NOx gas expelled from the heap surface and recycling the evolved gas to the first irrigation solution in a gas scrubbing process to further reduce loss of nitrate from the leach process.

The NOx gas expelled from the heap may be contained, for subsequent capture, by covering the heap with a sealed cover, for example an insulated thermofilm or any impermeable cover. The nitric oxide gas generated may be drawn away from the heap using a suitable suction pump system. The NOx leaving the heap may be readily oxidised by oxygen contained in the air being fed from a bottom of the heap and contained with the expelled NOx gases.

Additional air or oxygen, or oxygen enriched air may be injected during a scrubbing process to ensure the total oxidation of the NO to NO₂. The generated NO₂ may react with a scrubber solution to produce a scrubber effluent containing nitrous acid and nitric acid. In this way, the NO gas loss from the heap may be reduced to less than 5% and preferably 1% or less. The scrubber solution can either be wash water, raffinate solution or any aqueous media in which NO₂ can easily dissolve. Hydrogen peroxide or any other oxidant can also be added to the scrubber solution to help oxidise the unreacted NO absorbed into solution from the gas phase.

The crushed ore subject to acid agglomeration is agglomerated with acid only, without nitrate addition, to increase the porosity of the ore.

The nitrate concentration in the first irrigation solution may be high and may be in the range of 25 g/L-80 g/L nitrate, preferably 30-50 g/L nitrate.

The nitrate concentration in the first irrigation solution may be controlled according to the rate of mineral oxidation and heap temperature such that it is within the range 10 g/L to 80 g/L nitrate.

Air or oxygen, or oxygen enriched air may be passed into the heap at a base of the heap or at multiple points from the base of the heap to the top of the heap and/or at one or more levels above the base of the heap. The aeration rate may be controlled to a specific rate within the range 0.01-0.05 Nm³/h·t to maximise heap temperatures (heat generation rate) and minimise NOx gas loss from the heap.

Irrigation rates and aeration rates may be controlled to maximise heat generation within the heap, to minimise NO loss and to maximise the recycle of nitrate to the first irrigation solution. Example, but not limiting irrigation rates may be in the range of 2.5-6 L/h·m² and the specific mass flowrate of air (Ga in kg/h·m²) to irrigation rate (Gi in kg/h·m²) may be in the range 0.10-0.3.

On completion of the initial leach step, the method may include a rinse step, whereby the heap is rinsed with a low nitrate process water to recover excess nitrate in the heap.

Once a desired heap temperature has been reached through the oxidation of sulfide minerals and in particular pyrite, and while taking the necessary measures to conserve the generated heat in the heap, the method may include the additional steps of:
f) rinsing the heap with a low nitrate raffinate or process water to remove excess nitrate;
g) in a separate leach step, irrigating the heap with a second irrigation solution containing an acid nitrate solution.

The concentration of nitrate in the second irrigation solution may be low and in the range 0.5 g/L to 15 g/L nitrate.

The sulfide mineral ore may be selected from chalcopyrite, pyrite, covellite, chalcocite, bornite, enargite, copper oxide minerals or nickel sulfide minerals. This is not limiting.

The acid concentration in the first irrigation solution and the second irrigation solution may be within the range 5 g/L to 40 g/L and up to 50 g/L sulfuric acid.

The first irrigation solution in contact with the ore in the heap leach process reacts with dissolved iron in the ore to create solution oxidation potentials of 700 to 1200 mV versus SHE (standard hydrogen electrode).

The high oxidation potentials result in exothermic oxidation of sulfide minerals (e.g. pyrite and chalcopyrite) contained in the ore generating heat and increasing the heap temperature to temperatures in the range of 50° C. to 85° C.

The method may be carried out at atmospheric pressure and ambient temperatures in the environment outside of the heap.

The distribution of the crush size of the ore may be determined by the ore characteristics and may be in the range of a P₈₀ (80% passing size) of 4 mm to a Pao of 102 mm, including ROM samples. The selected particle distribution should contain sufficient amounts of fines in order to help with the initial generation of heat through pyrite oxidation.

The nitrate and nitrite salts may be added in a solution or may be added as a solid salt to the ore during heap construction.

The source of nitrate may be selected from nitric acid (HNO₃), NaNO₃, KNO₃ or any other soluble inorganic nitrate salt.

The source of nitrite may be selected from nitrous acid (HNO₂), NaNO₂, KNO₂ or any other soluble inorganic nitrite salt, or as a known impurity in the nitrate salt.

In operations where agglomeration with acid is an option, the addition of sulfuric acid may be of the order of 5 kg/T-20 kg/T. The acid addition is determined by:
Acid demand for leaching gangue minerals in the ore; for example, carbonates, iron oxides and silicate minerals, including chlorite and biotite.
Acid addition required to form a strong agglomerate and thereby, improve the permeability of the heap consisting of stacked agglomerated ore.

In the case where nitrate is added as nitric acid the sulfuric acid requirement will be decreased according to the concentration of H⁺ in solution derived from nitric acid (H⁺NO₃⁻).

The first and second irrigation solutions in contact with the ore in the leach stage are acidic with a pH lower than pH3 and preferably lower than pH2.

Each of the first and second irrigation solutions may contain iron, copper and other dissolved cations and anions as leach product species.

Recycled process solution containing nitrate and nitrite may be used in ore irrigation during the leach cycles.

The irrigation solution may be a raffinate solution from the solvent extraction operations, obtained from any part of the leach plant including the gas scrubber effluent or freshly prepared with acidified water by dissolving the desired ionic and cationic species.

The irrigation solution application rate and rate of air, or oxygen, or oxygen enriched air supply, are both carefully regulated to ensure NOx gases released within the heap are oxidised to nitrate and the nitrate generated is recycled in the irrigation solution through the capture of NOx gas or gas scrubbing. In this way, the efficiency of NOx gas oxidation to nitrate within the heap is in the range 70% to 80%, or 80% to 95% and up to 99% with capture of NOx gases expelled from the heap.

### DESCRIPTION OF THE DRAWINGS

The invention is further described by way of example with reference to the accompanying drawings in which:

FIG. 1a is a flow diagram according to one embodiment of the method of the invention which includes a first and a second leach step;

FIG. 1b is a flow diagram illustrating another embodiment of the method of the invention carried out without a second leach step;

FIG. 2 illustrates a gas scrubber circuit according to the invention;

FIG. 3 is a plot of the temperature profile of a heap wherein irrigation is carried out using a first irrigation solution followed by a second irrigation solution according to the method of the invention;

FIG. 4 is a plot of the temperature profile of a heap wherein irrigation is carried out using a second irrigation solution followed by a first irrigation solution;

FIG. 5 is a comparison plot of the copper extraction showing the effect of the irrigation solutions;

FIG. 6 is a comparison plot of pyrite conversion with time both with and without nitric acid regeneration.

FIG. 7 is a comparison plot of acid and nitrate concentrations over time with and without nitric acid regeneration;

FIG. 8 is a comparison plot of solution potential over time with and without nitric acid regeneration;

FIG. 9 is a comparison plot of pyrite conversion over time with and without nitric acid regeneration;

FIG. 10 is a comparison plot of acid and nitrate concentrations over time with and without nitric acid regeneration;

FIG. 11 is a comparison plot of solution potential over time with and without nitric acid regeneration;

FIG. 12 illustrates the column temperature profiles for cases 1 to 3 and 5 to 7 according to an example of the invention;

FIG. 13 illustrates the pyrite dissolution profiles for cases 1 to 3 and 5 to 7 according to an example of the invention;

FIG. 14 illustrates copper dissolution profiles for cases 1 to 3 and 5 to 7 according to an example of the invention;

FIG. 15 illustrates the chalcopyrite dissolution profiles for cases 1 to 3 and 5 to 7 according to an example of the invention;

FIG. 16 illustrates the net acid consumption profiles for cases 1 to 3 and 5 to 7 according to an example of the invention;

FIG. 17 illustrates the oxygen consumption profiles for cases 1 to 3 and 5 to 7 according to an example of the invention;

FIG. 18 illustrates the nitrate consumption profiles as sodium nitrate column for cases 1 to 3 and 5 to 7 according to an example of the invention;

FIG. 19 illustrates the effect of acid in irrigation solution or raffinate on copper recovery for ore with low acid consuming gangue and with high acid consuming gangue;

FIG. 20 illustrates the effects of nitrate concentration on copper recovery;

FIG. 21 illustrates the effect of the aeration rate on copper recovery according to an example of the invention;

FIG. 22 illustrates a comparison of copper extraction using different raffinate solutions according to an example of the invention;

FIG. 23 illustrates a comparison of reagent consumption using different solutions according to an example of the invention; and

FIG. 24 illustrates a column temperature profile as affected by the nitrate concentration of raffinate according to an example of the invention.

### DESCRIPTION OF PREFERRED EMBODIMENTS

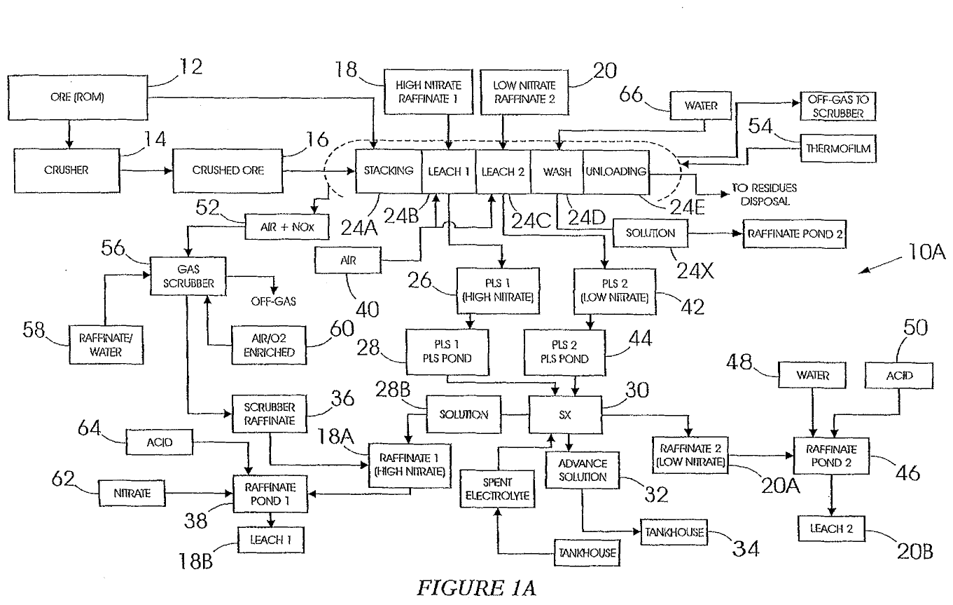

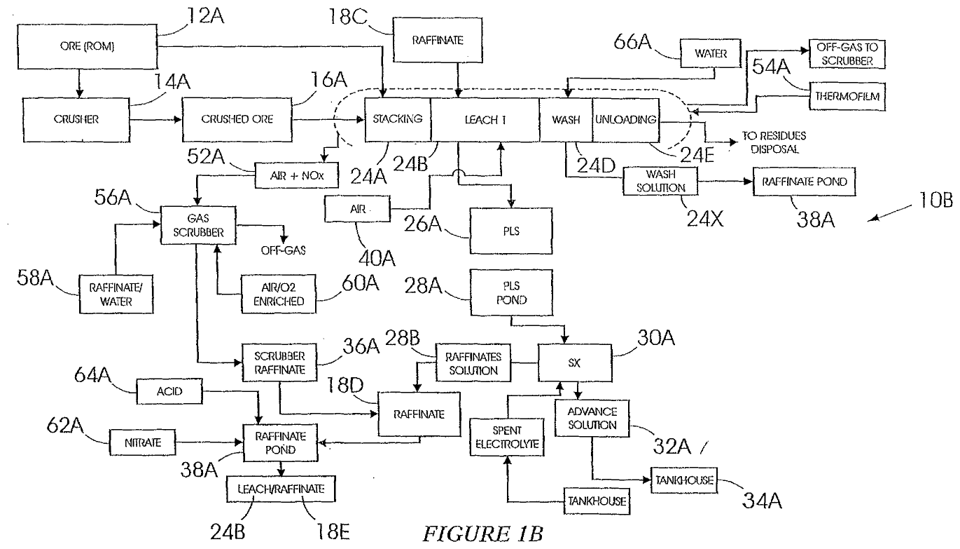

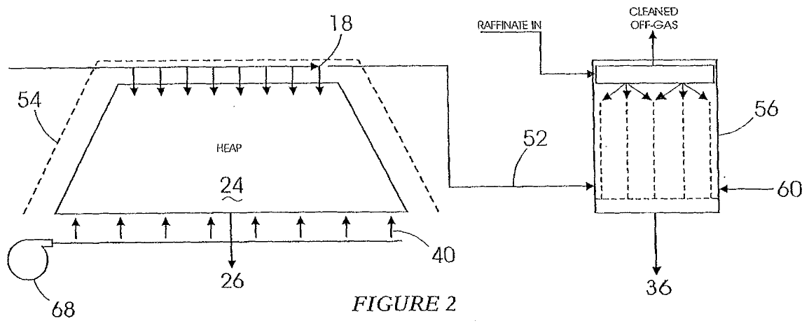

FIG. 1a shows a simplified flow diagram illustrating a method 10A of the invention which includes a first and a second leach step. FIG. 1b shows a simplified flow diagram illustrating a method 10B of the invention which excludes a second leach step. The method 10B is wholly incorporated in the method 10A; however, the method 10A includes an additional leach step. In the Figures, like reference numerals have been used to illustrate features common to each of the methods 10A and 10B. The methods 10A and 10B can be used for the leaching of primary sulfides, secondary sulfides, oxides and mixed copper ores.

In each of the methods 10A and 10B (see FIGS. 1a and 1b wherein corresponding features of method 10B have been included in parenthesis), ore in the form of run-of-mine (ROM) ore 12 (12A) is stacked 24A to form a heap 24. The ore 12 (12A) may be crushed in a crusher 14 (14A) to ensure that the crushed ore 16 (16A) is suitably sized, according to requirement. Preferably the ore has a crush size in the range of P₈₀ (80% passing size) of 4 mm to a P₈₀ of 102 mm.

In a leach step 24B, a first irrigation solution 18 (18C) is applied on top of the heap 24. The first irrigation solution contains an acid nitrate solution with a high nitrate concentration in the range of 25 g/l-80 g/L and a low nitrite concentration of between 50-500 ppm, preferably 100-500 ppm.

A resulting high nitrate and nitrite drainage solution, in the form of a pregnant leach solution 1 (PLS1) 26 (26A), from the leach step 24B, is collected in PLS 1 pond 28 (28A). The PLS1 26 (26A) is high in copper, nitrate and nitrite salts and other cationic and anionic species from the leached ore. The PLS 1 pond 28 (28A) feeds a solvent extraction (SX) plant 30 (30A) where copper is concentrated to produce an advance electrolyte solution 32 (32A) which is treated to recover metallic copper by means of electro-winning in an electro-winning tank-house 34 (34A). The copper stripped PLS1 28 (28A) constitutes a high nitrate and nitrite raffinate solution 28B and is mixed with a saturated scrubber raffinate 36 (36A) to produce a high nitrate, and nitrite, raffinate 18A (18D) which is then collected in the high nitrate, and nitrite, raffinate pond 38. Nitrate 62 (62A) is added to the raffinate 18A (18D), if necessary and a resulting solution 18B (18E) drains from the pond and is recycled to the leach step 24B as the high nitrate raffinate solution 18 (18C). Nitrate, acid, and water may be added to raffinate 1 or raffinate 2 to maintain required concentrations.

During the leach step 24B, forced aeration 40 (40A) is applied to the bottom of the heap 24 and/or to one or more levels above the bottom of the heap at the rate of 0.01-0.05 Nm³/hr·t.

As illustrated in FIG. 1a, the process 10A may include an optional second leach step. In this regard, a leach step 24C is carried out following the leach step 24B.

During the leach step 24C, forced aeration 40 is also applied from the bottom of the heap 24 and/or to one or more levels above the bottom of the heap at the rate of 0.01-0.05 Nm³/hr·t.

During the leach step 24C, a second irrigation solution in the form of a low nitrate raffinate solution 20 is applied to the heap 24 and is collected in the drainage at the bottom of the heap 24 as a low nitrate pregnant leach solution 2 (PLS 2) 42 which contains a high copper concentration and other cationic and anionic species from the leached ore.

The PLS 2 42 is collected in a PLS 2 pond 44 which feeds the solvent extraction (SX) plant 30 where copper is concentrated to produce the advance electrolyte solution 32 which is treated to recover metallic copper by means of electro-winning in the electro-winning tank-house 34. The resulting PLS 2 42, stripped of copper and enriched with acid, constitutes a low nitrate raffinate solution 20A which is collected in a low nitrate and nitrite raffinate pond 46.

In the low nitrate and nitrite raffinate pond 46, fresh water 48 may be added as make-up water in order to compensate for water loss in the heap leach circuit due to moisture in the leached residue ore, spillages, leakages and evaporation. Sulfuric acid 50 may be added in order, if required, to replace the acid that is consumed by the ore in the leach step 24C. A solution 20B from the pond 46 is recycled to the leach step 24C in the heap 24 as low nitrate raffinate 20.

During the leach steps 24B and 24C, nitrogen oxide gases (NOₓ) 52 (52A) are produced.

Nitric oxide (NO) evolved within the heap by the oxidative reaction of nitrate with sulfide minerals and oxidation of Fe(II) to Fe(III) is oxidised by oxygen to form NO₂ which is hydrolysed by solution within the heap forming nitrous acid and/or nitric acid shown by the simplified overall reactions:
nitrous acid formation; 2NO(aq)+½O₂ (aq)+H₂O→2HNO₂ (aq); and
nitric acid formation; NO+¾O₂+½H₂O=NO₃⁻+H⁺).

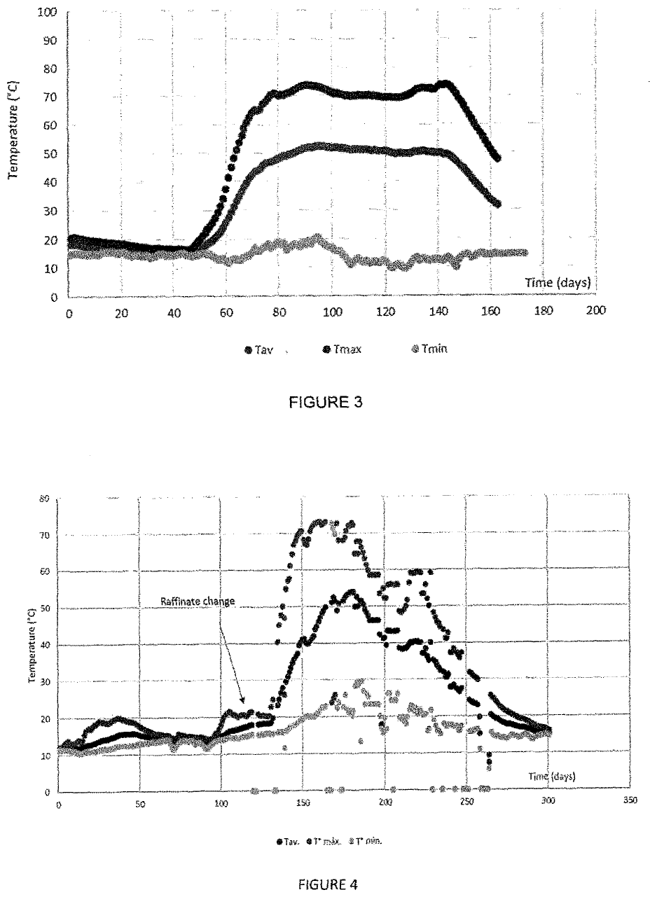

Referring to FIG. 3, NOx gases may be expelled from the heap, and therefore the method 10A and 10B includes provision for the capture of evolved acid fumes and volatile oxide gases of nitrogen through scrubbing. To recover NOx gases emitted from the surface of the heap 24, the heap 24 is covered with a sealed covering of any impermeable material, for example an insulated thermofilm 54 (54A) shown in dotted outline. A system of suction pumps 68 is used to draw the NOx (for example, NO and NO₂) 52 from the heap to a gas scrubber 56 (56A). The nitric oxide NO contained in the NOx gases within the heap, and in gases expelled from the heap, is expected to be readily oxidised by oxygen contained in the air being added into the heap, or by additional air, or oxygen, or oxygen enriched air is injected during gas scrubbing, to ensure total oxidation of the nitric oxide gas (NO) to NO₂ expelled from the heap and captured in the gas scrubber stage. The generated NO₂ is expected to react with the raffinate, process water or any aqueous media in which NO₂ can easily dissolve 58 (58A) and air or oxygen enriched air 60 (60A) to form the scrubber raffinate solution 36 (36A), which will be richer in nitrate as compared to the scrubber feed solution 58 (58A). Hydrogen peroxide (not shown) or any other oxidant can also be added to the scrubber solution to help oxidise the unreacted NO absorbed into the scrubber raffinate solution from the gas phase. In the scrubber 56 (56A) the concentration of NOx in the bulk gas stream is expected to be reduced from 50 ppm to less than 5 ppm before its discharge to the atmosphere.

The scrubber raffinate solution 36 (36A) is combined with high nitrate raffinate 18A (18D) from the leach step 24B to produce the solution 18B (18E) which is then recycled to the leach step 24B as the high nitrate raffinate solution 18 (18C). In the high nitrate raffinate pond 38 (38A), nitrate 62 (62A) may be added as make-up nitrate in order to compensate for nitrate loss in the heap leach circuit. Sulfuric acid 64 (64A), may also be added in order to replace the acid that is consumed by the ore in the leach step 24B.

Referring to FIG. 1b, following the leach step 24B, the heap is washed (24C) with water 66A and the resulting effluent 24X is transferred to the raffinate pond 38A.

Referring to FIG. 1a, following the leach step 24C, the heap is washed (24D) with water 66 and the resulting effluent 24X is transferred to the low nitrate raffinate pond 46.

The leach steps 24B and 24C ensure that the solution in contact with the ore 12 achieves high oxidation potentials of 750-1200 mV versus standard hydrogen electrode (SHE) resulting in the rapid oxidation of copper sulfide minerals and iron sulfide minerals including pyrite. The high solution oxidation potentials achieved (750-1200 mV vs. SHE) increase the sulfide mineral and pyrite oxidation rate which leads to an increase in heap temperature thereby enhancing the rate of metal dissolution from chalcopyrite and other associated sulphide minerals.

Efficient recycle of NO gas has not been demonstrated in a heap leach process operating at ambient pressures. Although NO₂ and NO gases may be generated during oxidation of minerals by nitrate and nitrite, NO gas has a very low solubility in aqueous solution whereas NO₂ is readily hydrolysed in water to form nitrous and/or nitric acid, and so is easily reabsorbed into the leach solution (3NO₂+H₂O=2HNO₃+NO).

The consumption of sodium nitrate is a major contributing factor to heap leach operating costs. The net consumption of nitrate is dependent on the ability to achieve in situ regeneration of nitrate, within the heap, according to reaction R1 below, which represents the overall reaction whereby nitric oxide is oxidised by oxygen in the gas phase to nitrogen dioxide which is then hydrolysed to nitric acid. The extent of in-situ regeneration of nitrate, within the heap, by reaction R1 depends on the residence time available for gas-phase reaction within the ore bed, which in turn depends on the aeration rate and concentration of oxygen in the gas phase.

A fraction of the nitric oxide generated by reaction R2 and reaction R3 within the ore bed of the heap does not react with oxygen and is lost from the ore bed in the gas flow at the top of the heap or column, representing nitrate consumption.

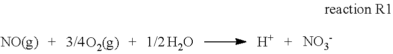

Fe(III) generated by Fe(II) oxidation according to reaction R2:

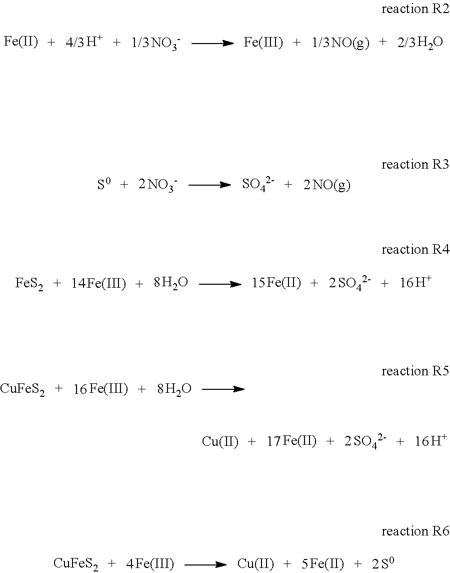

The nitrate consumption for leaching of pyrite and typical copper sulfide minerals from a primary copper ore may be represented by the following equations, where γ is the fraction of nitric oxide gas lost from the ore bed of the heap:

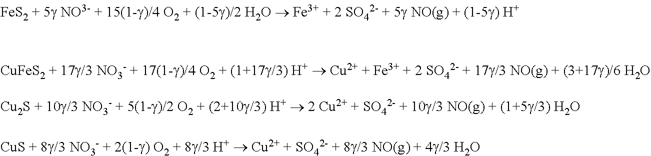

Consumption of the key reactants nitrate, acid and oxygen is dependent on the amount of NO gas that is recycled as nitrate, by reaction with oxygen within the heap, or by separate capture and oxidation of NO gas expelled from the heap. Oxidation of NO gas to nitrate within the heap by aeration of the heap is the most efficient method for recycle. The effect of the percentage fraction loss of NO gas on reagent consumption is shown in Table 1 below. For the example results shown in Table 1, a 5% NO loss results in zero net acid consumption, while NO losses below 5% result in net acid generation (shown as negative acid consumption). The nitrate consumption increases in proportion to the increase in NO loss.

TABLE 1
Percentage Fraction NO Gas Lost from Heap
Leach and Resulting Reagent Consumptions

| | 1% Loss | 2% Loss | 5% Loss | 10% | 20% | 30% |
|---|---|---|---|---|---|---|
| | NO | NO | NO | Loss NO | Loss NO | Loss NO |
| Reagent | Consumption (kg/T ore) | | | | | |
| Nitrate as NaNO₃ | 0.7 | 1.4 | 3.6 | 7.2 | 14.5 | 21.7 |
| Sulfuric Acid | −1.7 | −1.3 | 0.0 | 2.1 | 6.3 | 10.5 |
| Oxygen | 20.3 | 20.1 | 19.4 | 18.4 | 16.4 | 14.3 |

The results are based on treatment of a primary copper ore containing 1% chalcopyrite, 0.24% chalcocite and 3% pyrite. The pyrite oxidation was 45% and the total copper dissolution achieved was 82%.

Table 2 presents results showing the effect of aeration rate on the fraction γ of nitric oxide gas lost from the ore bed and the associated consumption of sodium nitrate. The results suggest that a decrease in aeration rate from 0.04 Nm3/h·t to 0.02 Nm3/h·t will lower the nitrate consumption, expressed as sodium nitrate by 3-4 kg/t of ore treated.

TABLE 2
Effect of aeration Rate on the Fractionγ of nitric oxide gas lost from the
ore bed and the associated consumption of sodium nitrate based on model prediction.

| [NO₃^{_{−}}] | [H₂SO₄] | Gᵢ | Gₐ | Cpy | Py | Cu | NAC | | NaNO₃ |
|---|---|---|---|---|---|---|---|---|---|
| g/L | g/L | L/h · m² | Nm³/h · t | % | % | % | kg/t | γ | kg/t |
| 50 | 20 | 4.5 | 0.02 | 82 | 51 | 83 | 11.1 | 0.20 | 16.0 |
| 20 | 20 | 4.5 | 0.02 | 77 | 49 | 80 | 11.5 | 0.14 | 10.6 |
| 20 | 15 | 4.5 | 0.04 | 68 | 45 | 71 | 8.4 | 0.17 | 11.0 |
| 20 | 15 | 4.5 | 0.03 | 71 | 46 | 75 | 7.8 | 0.14 | 9.6 |
| 20 | 15 | 4.5 | 0.02 | 73 | 47 | 76 | 7.2 | 0.11 | 8.1 |
| 20 | 15 | 4.5 | 0.01 | 43 | 37 | 51 | 8.1 | 0.07 | 3.5 |
| 10 | 20 | 4.5 | 0.04 | 62 | 42 | 66 | 12.6 | 0.16 | 9.5 |
| 10 | 20 | 4.5 | 0.03 | 67 | 44 | 70 | 12.0 | 0.12 | 7.9 |
| 10 | 20 | 4.5 | 0.02 | 70 | 45 | 73 | 11.8 | 0.10 | 6.5 |
| 10 | 20 | 4.5 | 0.01 | 41 | 35 | 49 | 12.2 | 0.06 | 2.9 |
| 10 | 15 | 4.5 | 0.04 | 50 | 36 | 56 | 9.0 | 0.16 | 8.3 |
| 10 | 15 | 4.5 | 0.03 | 56 | 39 | 60 | 8.2 | 0.12 | 6.7 |
| 10 | 15 | 4.5 | 0.02 | 44 | 34 | 50 | 8.5 | 0.06 | 3.1 |
| 10 | 15 | 4.5 | 0.01 | 32 | 29 | 41 | 8.9 | 0.05 | 1.9 |

A maximum nitrate consumption for economic recovery of metals from an ore is 10 kg/T ore treated and preferably 5 kg/T or less.

Dissolution of pyrite by oxidation with nitrate ions is very slow in the absence of nitrite ions. However, addition of small amounts of nitrite (as low as 50 ppm) can initiate oxidation of pyrite with the mixed potential increasing by some 50-70 mV while the solution potential increases to above 0.9 V.

### EXAMPLES

### Example 1. Column Leach Test

The performance of the method of the invention (hereinafter referred to as the “NitrothermaL process”) was tested by the applicant on a primary copper sample containing 80% chalcopyrite as the main copper source with a copper grade of 0.49% and 3% pyrite with conditions presented in Table 3 below.

TABLE 3
Column Test Conditions

| | | Column 1 | Column 2 | Column 3 |
|---|---|---|---|---|
| ROM Sample - Particle Size | P80 | 1″ | 1″ | 1″ |
| Acid dosage | kg/t | 0 | 0 | 0 |
| Agglomeration | | No, Loaded dry | | |
| Temperature | °C | Auto Gen | Auto Gen | Auto Gen |
| Aeration rate | Nm3/hr · t | 0.04 | 0.05 | 0.06 |
| Irrigation rate | L/m2 · hr | 4.5 | 4.6 | 4.7 |
| Irrigation Time | hrs/day | 24 | 24 | 24 |
| Cure Period | days | 0 | 0 | 0 |
| Column Height | m | 10 | 10 | 10 |
| Column Diameter | m | 0.9 | 0.9 | 0.9 |
| Mass Loaded | t | 10.2 | 10.7 | 10.5 |
| Raffinate Type | | Raffinate 1 & | Raffinate 3 & | Raffinate 1 & |
| | | Raffinate 2 | Raffinate 1 | Raffinate 2 |

The sample was received as Run of Mine (ROM), blended to obtain a representative sample and loaded dry in the three columns above. It is important to state that because of the blasting system used at the mine, the particle size distribution ROM is on average finer P₈₀<2.5″ as compared to standard ROM samples in other operations.

Once loaded, the ore was irrigated with raffinate solution whose compositions are presented in Table 4 below. The columns 1 and 3 were initially irrigated with raffinate 1 until day 120 before a change was made to raffinate 2. On the other hand, column 2 was initially irrigated with raffinate 3 before a change was made at day 135 to raffinate 1. During irrigation, an aeration rate of 0.04 Nm³/hr·t was used.

TABLE 4
Raffinate Composition

| | CuT | Fe(T) | Fe + 2 | H+ | Cl | | Nitrate | SO4 | Eh |
|---|---|---|---|---|---|---|---|---|---|
| | (g/l) | (g/l) | (g/l) | (g/l) | (g/l) | Density | (g/l) | (g/l) | (mV) |
| Raffinate 1 | 0.56 | 1.40 | 0.19 | 20 | 1.51 | 1.26 | 50 | 130 | >850 mV |
| Raffinate 2 | 0.56 | 1.40 | 0.19 | 20 | 1.51 | 1.26 | 10 | 130 | >850 mV |
| Raffinate 3 | 0.56 | 1.40 | 0.19 | 8 | 1.51 | 1.26 | 0 | 130 | 800 mV |

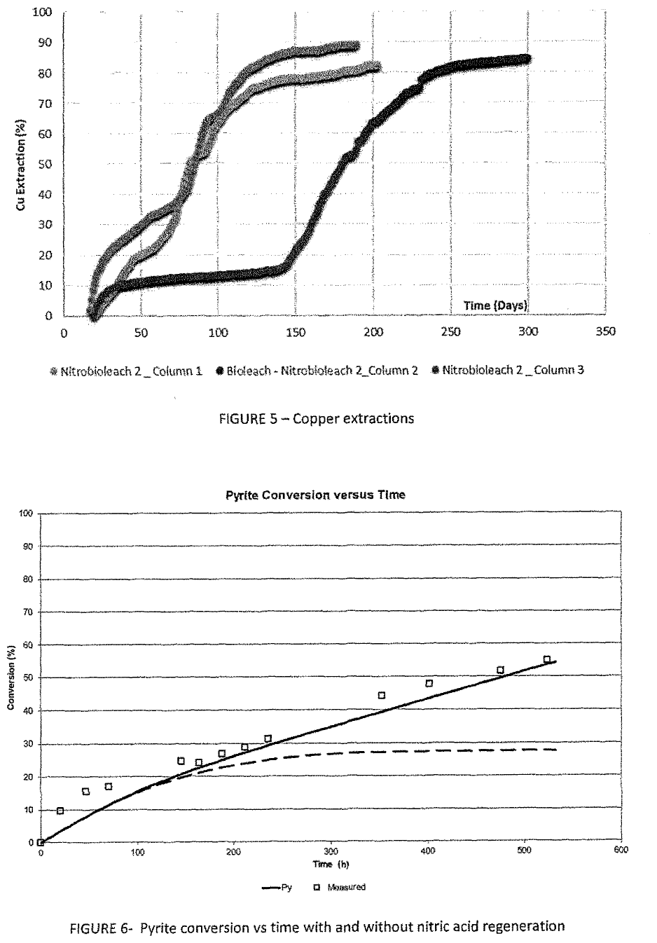

FIG. 3 shows that as irrigation proceeds, the exothermic oxidation of pyrite leads to an increase in temperature in the column. A maximum of 70° C. was attained as of day 80, which was maintained for 70 days before it started dropping. An average temperature of 50° C. in the column was ideal for the leaching of chalcopyrite as can be observed in columns 1 and 3 respectively. However, as shown in FIG. 4, there was no temperature generation in a column that was initially operated under bioleach conditions (i.e. low nitrate conditions) and there was minimal copper extraction as shown in FIG. 5. However, once the decision was taken to change the raffinate for the column on day 129, it took less than 10 days for the temperature to increase in the column. The temperature increase was then followed by a corresponding increase in copper extraction, attaining a maximum of 83% copper dissolution—see FIG. 5.

### Example 2: Pyrite Oxidation by Acidified Nitrate Solution

Experiments were carried out to study the oxidation of pyrite in flasks with solutions of sulphuric acid and sodium nitrate for a range of acid and nitrate concentrations. The measured data include the acid and iron concentrations, solution potential and the pyrite conversion as a function of reaction time. The pyrite conversion is calculated from the iron concentrations.

The overall rate of reaction for ferrous iron for chemical reactions can be written as:

$$\frac{d [ {Fe}^{2 +} ]}{d t} = - {{{k}_{3} [ {Fe}^{2 +} ]}^{0.4} [ {H}^{+} ]}^{2} [ {NO}_{3}^{-} ] + 15 {k}_{2} \frac{{m}_{Fe {S}_{2}}}{V} \sqrt{\frac{[ {Fe}^{3 +} ]}{[ {Fe}^{2 +} ]}} ( 1 - {α}_{{FeS}_{2}} )$$

where m_{FeS2} and V are the mass of pyrite (mol) and volume of solution (L) in the flask reactor, respectively.

Expressions similar to the above equation can be written for the rates of change of the other species in the chemical reactions, namely FeS₂, Fe³⁺, H⁺, NO₃⁻ and NO.

### Experiment 1: Nito 60

The initial conditions for the Nitro 60 test are: [Fe2+]0=0.073 g/L, [Fe3+]0=1.24 g/L, [H₂SO₄]0=141 g/L, [NO3-]O=88 g/L and [FeS2]0=125 g/L (50 g of pyrite in 0.4 L of leach solution). The solids (pyrite) loading for the flask test is typical of a heap leach with pyrite grade around 1 wt. %.

FIG. 6 shows the measured and calculated pyrite conversion during the 22-day leach test. The dashed line is the calculated conversion without nitric acid regeneration while the solid line is the calculated conversion with nitric acid.

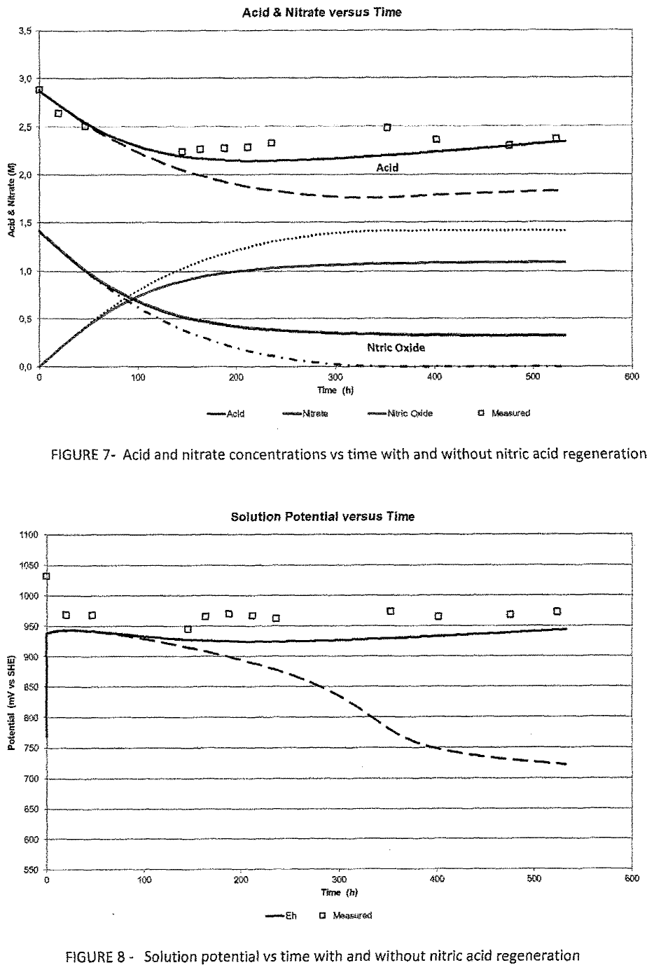

FIG. 7 shows the measured and calculated acid concentrations and the calculated nitrate concentration during the leach test. The solid lines and dashed lines are the calculated concentrations with and without nitric acid regeneration, respectively.

FIG. 8 shows the measured and calculated solution potential during the leach test. The solid and dashed and lines are calculated with and without nitric acid regeneration, respectively.

The calculated results in FIG. 7 show that without nitric acid regeneration the initial nitrate in the leach solution is consumed after around 10 days. At the same time, the calculated acid concentration (FIG. 7), solution potential (FIG. 8) and pyrite conversion (FIG. 6) are underestimated compared to the corresponding measured values. The effect of including nitric acid regeneration in the reaction scheme is shown by the solid lines which are clearly in much better agreement with the measured data.

The fraction of nitric oxide (γ) that is not oxidised to nitric acid according to the following equation:

NO(g)+¾O₂(g)+½H₂O→H⁺+NO₃⁻, is γ=0.39.

The stoichiometry for the overall oxidation of pyrite can be written in terms of γ as:

$${FeS}_{2} + 5 γ {NO}_{3}^{−} + \frac{15}{4} ( 1 − γ ) {O}_{2} + \frac{1}{2} ( 1 − 5 γ ) {H}_{2} O \to {Fe}^{3 +} + 2 {SO}_{4}^{2 −} + 5 γ NO ( g ) + ( 1 − 5 γ ) {H}^{+}$$

For γ=0.39, it can be seen that dissolution of 1 mol of FeS₂ consumes 0.95 mol of H+ and 1.95 mol of NO₃⁻, consistent with the final concentrations of acid and nitrate in FIG. 7.

Without nitric acid regeneration, then γ=1, and dissolution of 1 mol of FeS₂ consumes 4 mol of H+ and 5 mol of NO₃⁻.

The results demonstrate that under the conditions defined nitric acid is regenerated, significantly reducing nitrate consumption, increasing the extent of pyrite oxidation, and maintaining higher solution oxidation potentials (Eh, mV versus SHE), in the oxidation of pyrite by acid nitrate indicated by reaction in paragraph [00106].

### Experiment: Nitro 30

The initial conditions for the Nitro 30 test are: [Fe2+]0=0.067 g/L, [Fe3+]0=1.28 g/L, [H2SO4]0=163 g/L, [NO3-]0=44 g/L and [FeS2]0=125 g/L (50 g of pyrite in 0.4 L of leach solution).

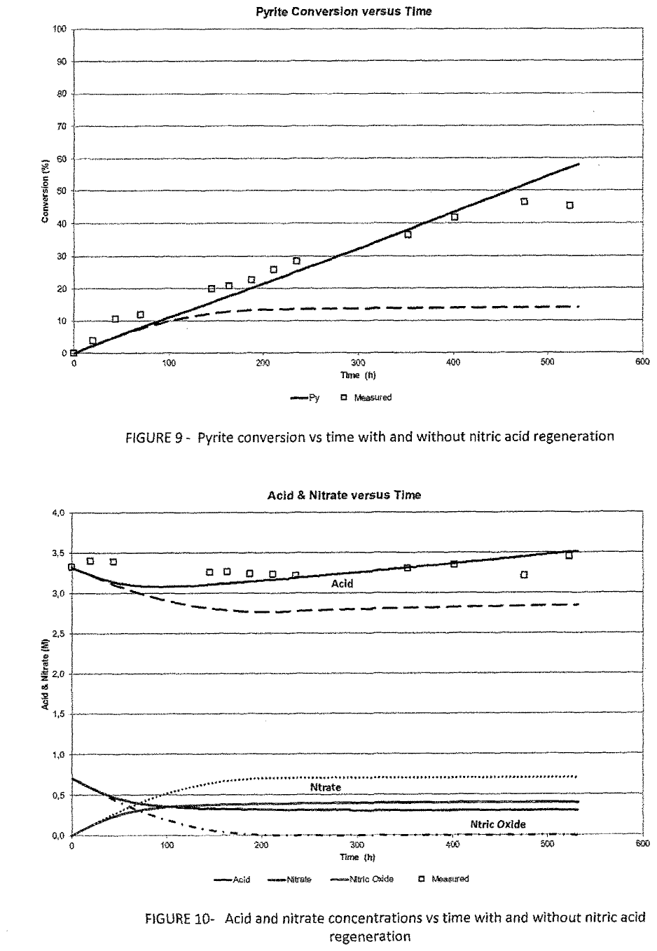

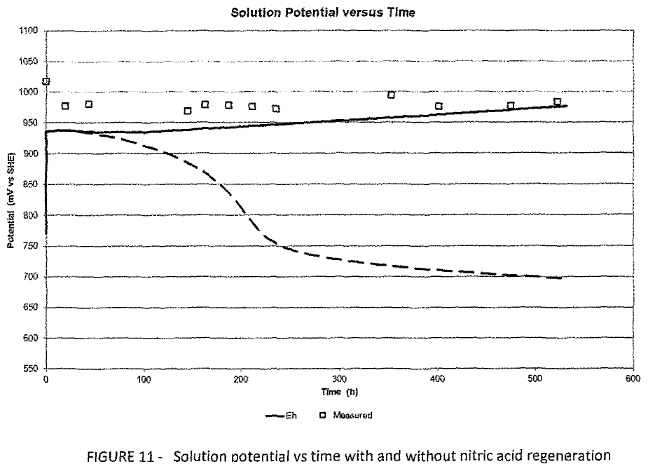

FIGS. 9 to 11 show the measured and calculated pyrite conversion, the acid and nitrate concentrations, and the solution potential during the 22-day leach test. The solid lines and dashed lines are the calculated results with and without nitric acid regeneration, respectively. The trends are consistent with the trends for Nitro 60.

The fraction of nitric oxide that is not oxidised to nitric acid according to reaction equation 1 (R1) is γ=0.13. That is, a 13% loss of evolved NO gas, or 87% recycle of NO gas regenerating nitrate and acid.

For γ=0.13, it follows that dissolution of 1 mol of FeS₂ generates 0.35 mol of H⁺ and consumes 0.65 mol of NO₃⁻, consistent with the final concentrations of acid and nitrate in FIG. 10.

The results show that in the test Nitro 30, the regeneration of nitrate was greater with only 13% loss of NO gas, demonstrating improved extent of pyrite oxidation, reduced acid consumption and higher solution oxidation potentials.

### Example 3: Demonstrating Effect of Operating Conditions on Leach Performance

Extensive experimental tests were undertaken in 10 m simulation columns (simulation column design given in U.S. Pat. No. 7,727,510 B2, 01 Jun. 2010). Results of the experimental programs were used to test effects of the process variables and reagent additions in the NitrothermaL leach defining conditions that achieve high rates of heat generation by pyrite oxidation and maximise copper recovery with minimal nitrate consumption. Tests were carried out with crushed and run of mine primary (hypogene) copper ores.

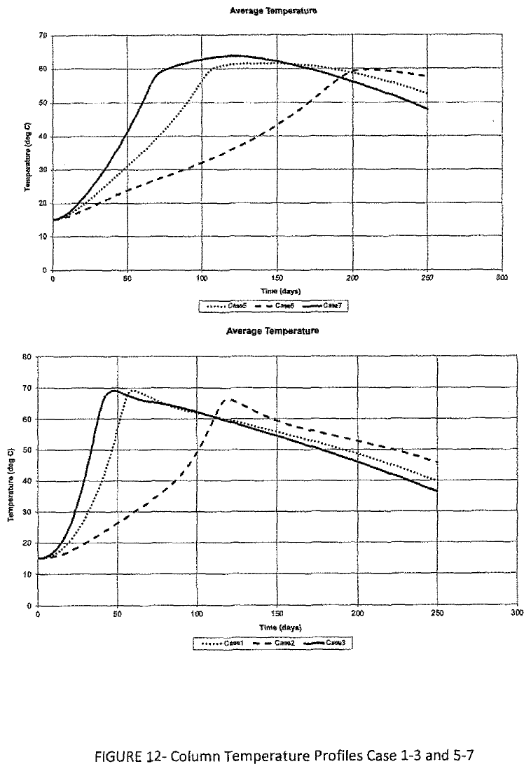

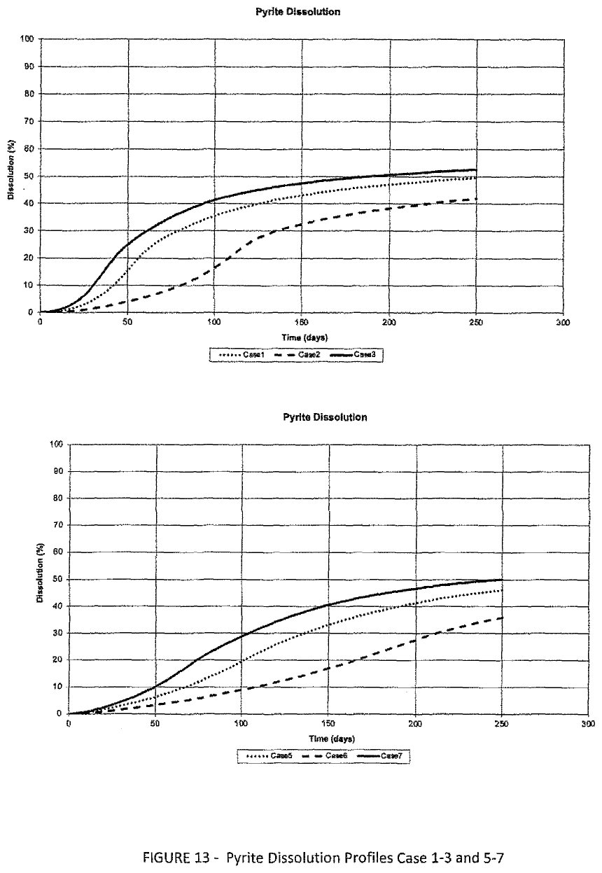

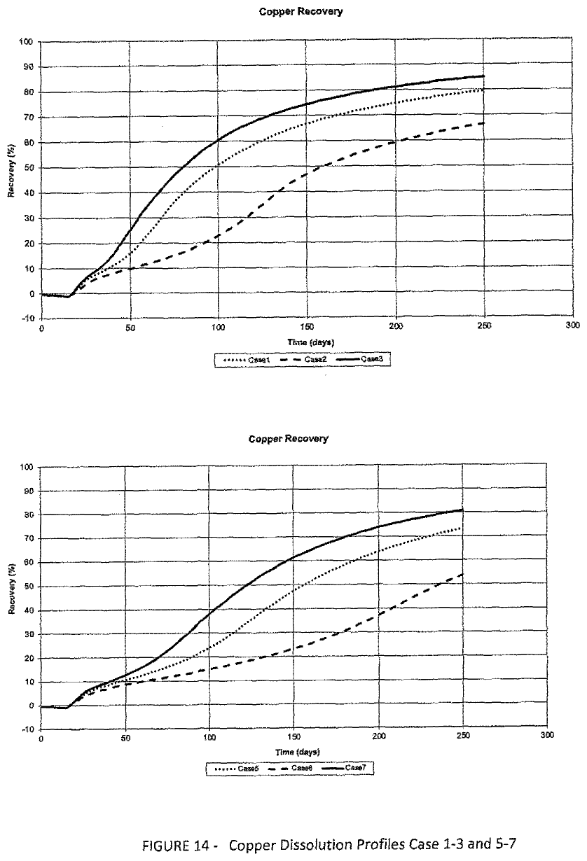

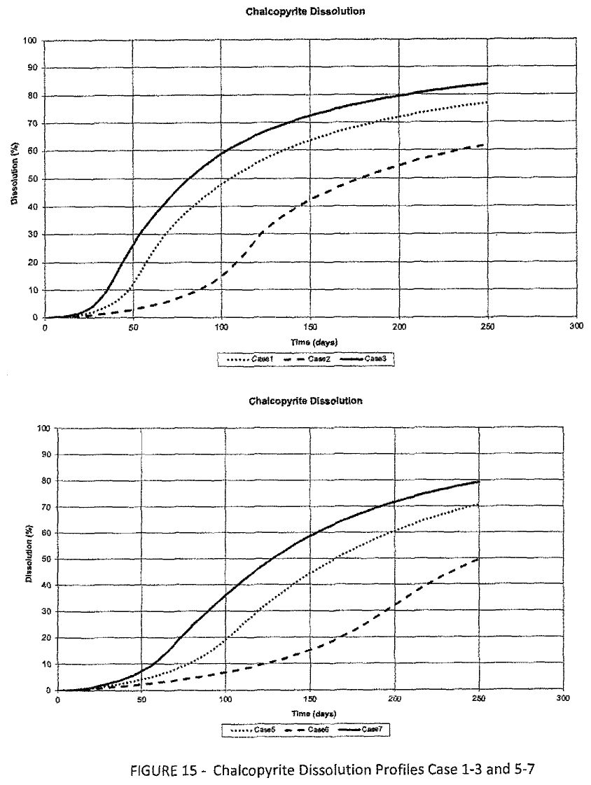

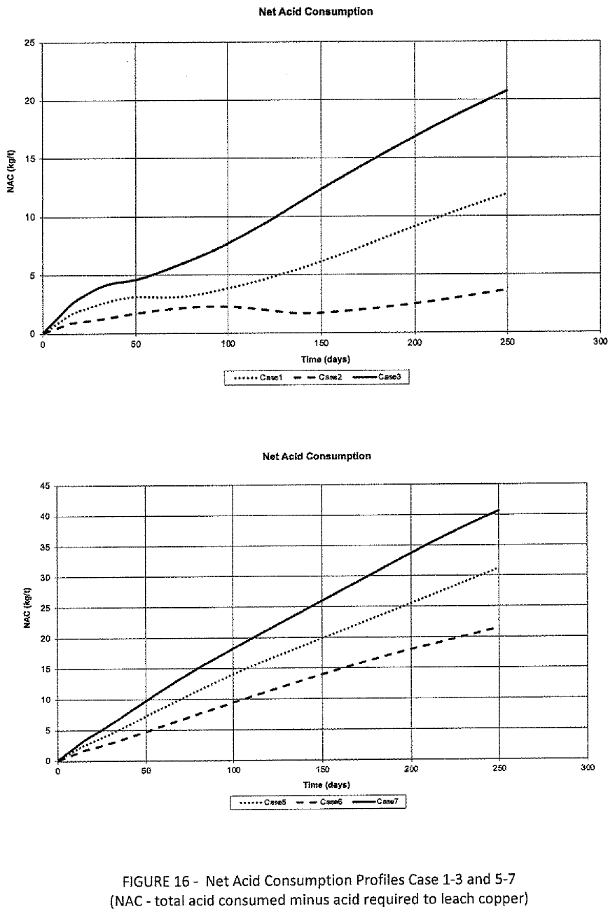

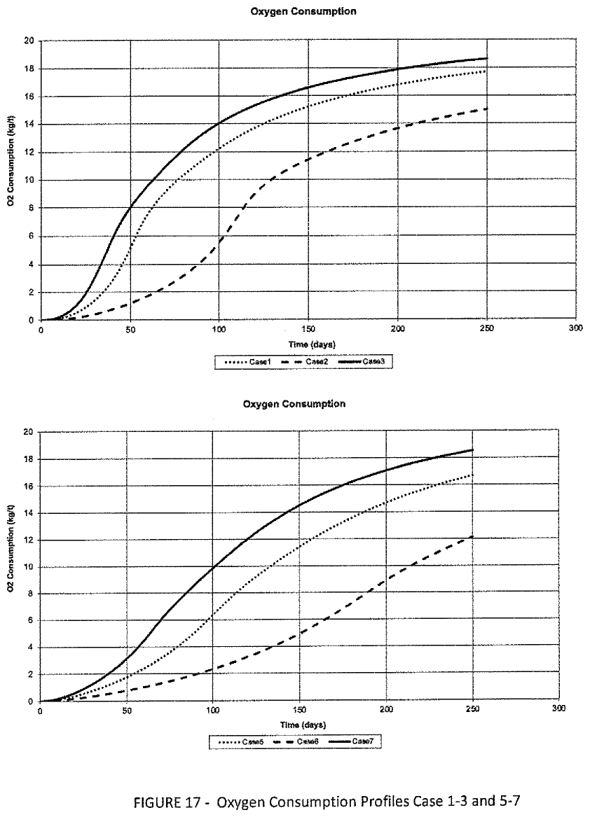

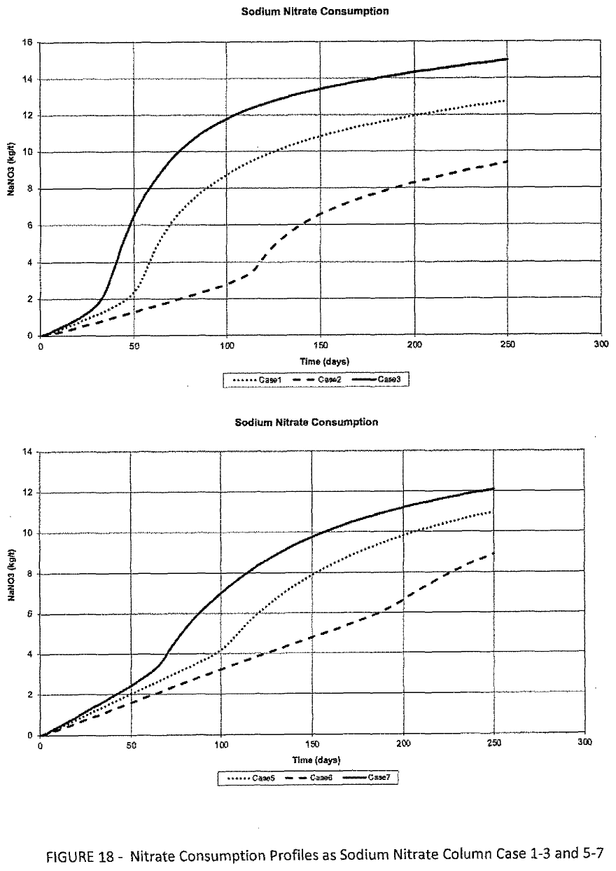

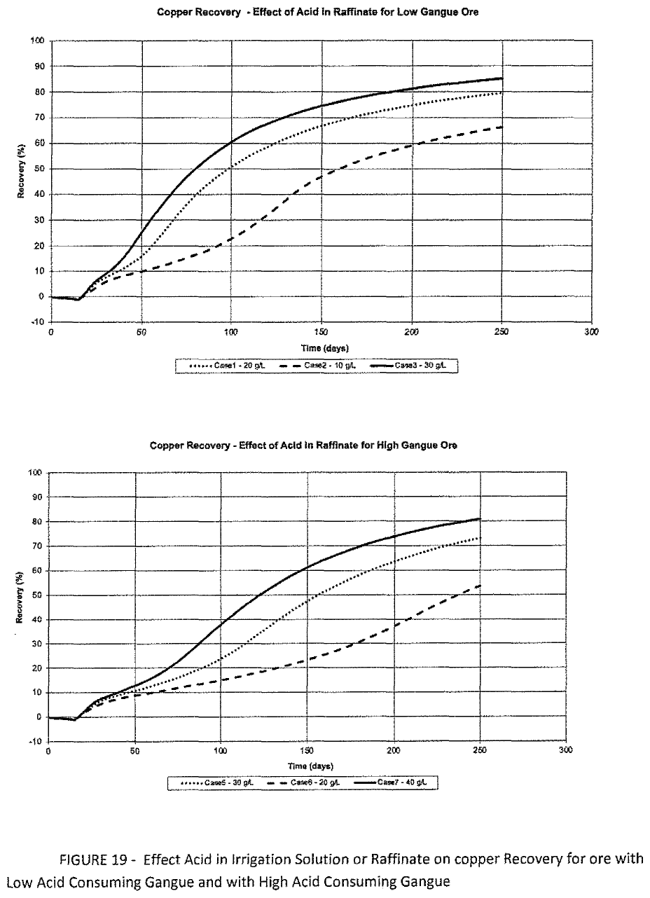

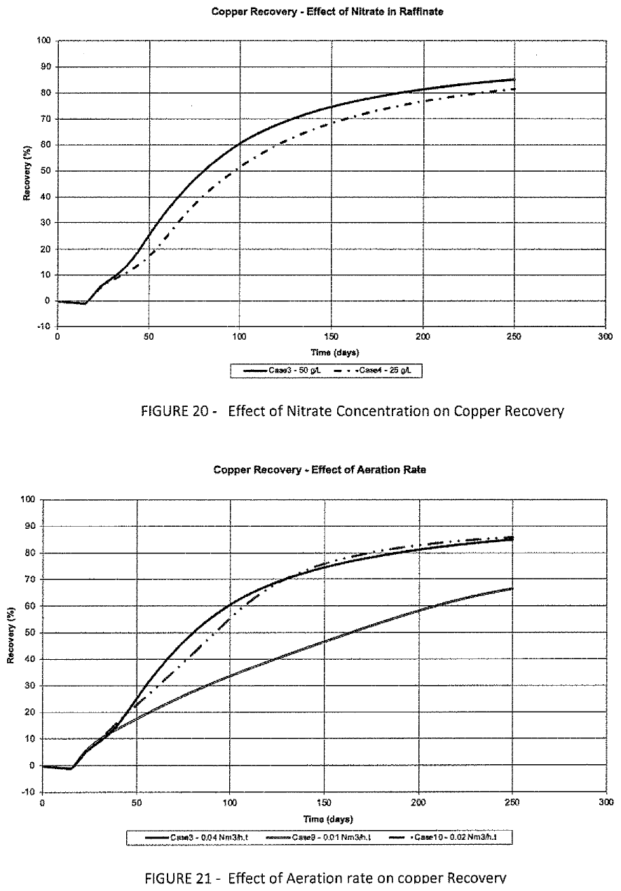

Model parameters were derived from the test data and model outputs were tested and verified against results of the 10 m simulation column tests. The model results were then used to describe the observed results. Examples of the column experiments completed as 10 separate case studies are summarized in Table 6 below and results of the case studies showing effects of operating conditions and reagent concentrations are shown in FIGS. 12 to 21.

Ore characteristics used in the simulation of the column leach tests are set out in Table 5 below:

TABLE 5
Ore characteristics

| Item | Units | Value |
|---|---|---|
| Particle size | P₈₀ (mm) | 50 |
| Pyrite content | Mass % | 3 |
| Total Cu | Mass % | 0.43 |
| Fraction of Cu as chalcopyrite | % | 81 |
| Low GAC* Biotite + Chlorite | Mass % | 1 |
| High GAC* Biotite + Chlorite | Mass % | 10 |

*GAC—Gangue Acid Consumption

Test conditions Case Studies 1 to 10

TABLE 6
Column Case Studies

| | Case | Case | Case | Case | Case | Case | Case | Case | Case | Case |
|---|---|---|---|---|---|---|---|---|---|---|
| Units | 1 | 2 | 3 | 4 | 5 | 6 | 7 | 8 | 9 | 10 |
| H₂SO₄ | 20 | 10 | 30 | 30 | 30 | 20 | 40 | 30 | 30 | 30 |
| (g/L) | | | | | | | | | | |
| NO₃^{_{−}} | 50 | 50 | 50 | 25 | 50 | 50 | 50 | 25 | 50 | 50 |
| (g/L) | | | | | | | | | | |
| Gangue | Low | Low | Low | Low | High | High | High | High | Low | low |
| Air | 0.04 | 0.04 | 0.04 | 0.04 | 0.04 | 0.04 | 0.04 | 0.04 | 0.01 | 0.02 |
| (Nm³/h · t) | | | | | | | | | | |

The acid and nitrate concentrations refer to the concentrations in the irrigation solution of the 10 m simulation column tests.

Gangue refers to the acid consuming non-sulfide minerals in the ore and are predominantly silicate minerals, for example chlorite and biotite. “Low” refers to low GAC (gangue acid consumption) (relatively low content of chlorite and biotite) and “high” refers to high GAC (typically relatively high chlorite and biotite content.

Air is the aeration rate to the column, expressed as Nm³ per hour per metric t ore loaded in the column (Nm³ defined here as the air flow at 0° C. and 101.325 kPa).

### Explanation of Test Conditions Examined:

Case Studies 1 to 3 show the effect of increasing acid concentration for a low acid consuming gangue at a nitrate concentration of 50 g/L and fixed aeration rate of 0.04 Nm3/h·t.
Case 4 and Case 8 show the effect of a reduced nitrate concentration in the irrigation solution for a low and high acid consuming gangue respectively.
Case studies 5 to 7 show the effect of acid concentration for a high acid consuming gangue.
Case studies 9 and 10 show the effect of lower aeration rates.

### Summary of Results Case Studies 1-10:

a) Higher rates of pyrite oxidation resulted in higher temperatures.
b) Higher temperatures increased chalcopyrite dissolution and consequently copper recovery.
c) Higher acid concentrations of 30 g/L for the ore types considered was necessary to sustain nitrate oxidation of sulfide minerals and achieve maximum copper recoveries.
d) NAC increased with increased acid concentration in the irrigation solution.
e) Ore with relatively high gangue acid consumption demanded increased acid addition, for example 40 g/L in the irrigation solution for Case 7, in order to sustain sulfide mineral oxidation reactions and maintain copper recovery close to 80%.
f) Nitrate addition of 50 g/L in the irrigation solution ensured maximum copper recovery.
g) Higher aeration rates of 0.04 Nm3/h·t ensured maximum copper recovery and resulted in relatively lower nitrate consumption (shown by results for case 3 and case 7).

### Example 4: Gas Capture and Scrubbing Test

A primary sulfide sample, loaded into a 10 m column, was leached under nitrate conditions with forced aeration introduced at the bottom of the column. The column off-gasses were sent to a scrubber containing 400 L of water, by a suction system and after 4 days of operation, the water was analysed for nitrate and acid. The results obtained show that after the 4^{th} day, when the water test was stopped, the pH had dropped from pH6.8 to pH1.5, and the solution contained 19.3 g/L of acid and nitrate content of 26 g/L—see Table 7 below. The solution was suitable as a process liquor for recycle in the leach process. The contained nitrate in the scrubber solution is equivalent to 1 kg of nitrate/t of ore recycled to the process in 4 days of gas capture, for a column loaded with 10 t of fresh ore. The recovery of the evolved gas translates to a major reduction to the process operating cost. The nitrate recovered reduces the process nitrate consumption from 15 kg/t with zero NOx has capture, to only 3 kg/t with recovery of NOx gases by the gas scrubber operation.

TABLE 7
Scrubber Solution Analysis Results

| | pH | Acid (g/L) | Nitrate (g/L) |
|---|---|---|---|
| Water before test | 6.8 | 0 | 0 |
| Water after test | 1.5 | 19.3 | 26 |

The column off-gas was also measured before and after the gas scrubber unit. The results show a gas scrubbing efficiency of more than 90% using water, Table 8. The gas before the scrubber contains more NO because most of the NO₂ produced is expected to react with the raffinate solution directly within the column.

TABLE 8
Column gas results

| | NO(ppm) | NO₂ (ppm) |
|---|---|---|
| Before scrubber | 40 | 20 |
| After scrubber | 5 | 3 |

The method of the invention provides an effective solution for the regeneration of nitrate, reducing the operating costs of the process. Additionally, the method ensures high oxidation potentials to allow efficient leaching of the sulfide mineral ores without the need for agglomerating and curing steps.

### Example 5—a Two-Stage Leach

The effect of changing raffinate solution from high nitrate to low nitrate on the overall nitrate demand on the process was demonstrated using the samples with the characteristics presented in Table 9below:

| | Unit | M2 | M1 |
|---|---|---|---|
| Ore PSD, P₈₀ | inch | 1.5 | 0.875 |
| Chalcopyrite | % | 75 | 75 |
| Irrigation: | | | |
| High Nitrate (50 g/L) | | Yes | Yes |
| Low Nitrate (30 and 10 g/L) | | Yes | No |

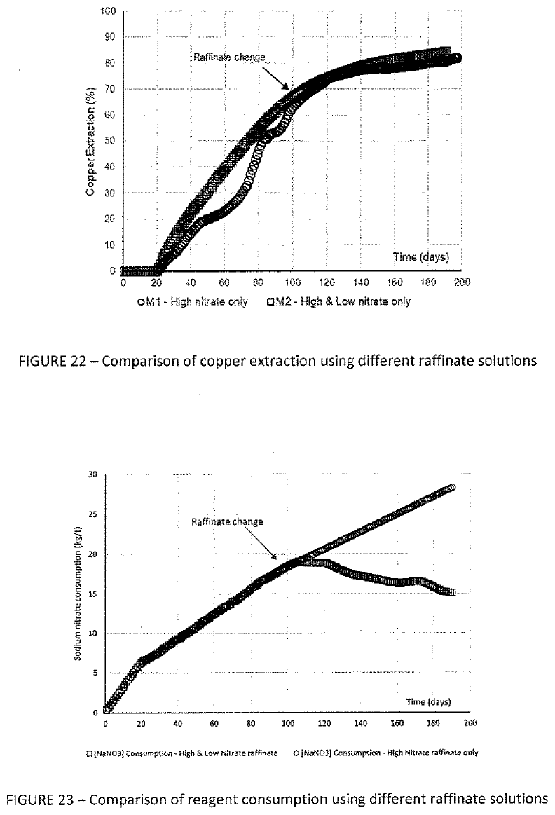

Sample M1 was irrigated with raffinate solution containing only high nitrate at 50 g/L nitrate throughout the leach cycle while in sample M2 the raffinate was changed from high nitrate to low nitrate once the desired leach temperature was achieved. After 200 days of irrigation, the results show that there is no significant difference in final extractions for columns (83% vs 81%) operated with or without change in raffinate solutions—FIG. 22. This is mainly because a change in raffinate is only done when the column has attained the required temperature for leaching of chalcopyrite: >55° C. and after that it is only necessary to sustain the temperature and ensure sufficient oxidant (ferric/nitrate) is available to continue mineral leaching. The benefit of changing to a lower nitrate concentration is a saving in reagent consumption (sodium nitrate). The results show that 28 kg/t of NaNO₃ was consumed in column leach test M1, where only a high nitrate raffinate of 50 g/L was used. The consumption was reduced to 15 kg/t NaNO₃ in column test M2 using a two-stage leach, with stage one irrigation using a high nitrate concentration and stage two irrigation using a low nitrate concentration (30 g/L and 10 g/L), see FIG. 23. Thus, the two-stage leach achieved a sodium nitrate reagent saving of 46%. The capture of NOx gases in this column test was limited to 80% accounting for the sodium nitrate consumption of 15 kg/t.

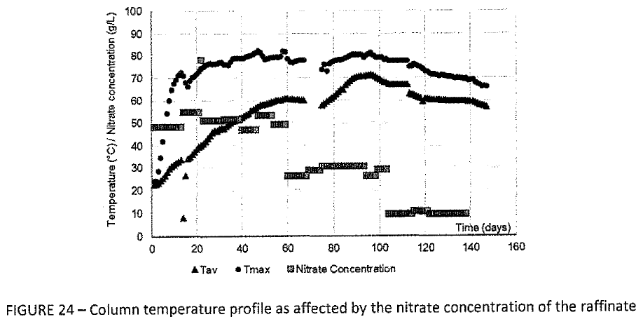

In another test, using the sample with similar characteristics to M2, the effect of changing the raffinate solution on heat generated is presented. The column was initially irrigated with 50 g/L nitrate raffinate solution and once the required temperature was attained, the nitrate raffinate concentration decreased to 30 g/L and later to 10 g/L. The results show that the temperature remained high and suitable for chalcopyrite leaching despite the decrease in the nitrate concentration of the raffinate irrigation solution—see FIG. 24.

1. A method of extracting copper from a sulfide mineral ore selected from ROM ore, crushed ore, or crushed ore subject to acid agglomeration, comprising:
a) stacking the ore to form a heap;
b) irrigating the heap, in a leach step, with a first irrigation solution containing an acid nitrate (NO₃⁻) solution in which the nitrate concentration is in the range of 25 g/L to 80 g/L, and nitrite (NO₂) at a concentration of between 50 ppm to 500 ppm thereby to cause oxidation of sulfide minerals within the heap;
c) adding air, oxygen, or oxygen enriched air into the heap;
d) oxidising nitric oxide gas released during the oxidation of the sulfide minerals within the heap by oxygen to form nitrogen dioxide (NO₂); and
e) hydrolysing the nitrogen dioxide (NO₂) to form nitric acid and/or nitrous acid in the first irrigation solution within the heap, to continue the leaching step and to reduce the loss of nitric oxide from the heap.

2. The method of claim 1 wherein the loss of nitric oxide gas from the heap is reduced to between 5% to 30%.

3. The method of claim 1, further comprising capturing nitric oxide gas expelled from the heap surface and recycling the evolved gas to the first irrigation solution in a gas scrubbing process.

4. The method of claim 3, wherein the nitric oxide gas is contained, for subsequent capture, by covering the heap with an impermeable cover.

5. The method of claim 4, wherein the nitric oxide gas is drawn from the heap by a suction pump system.

6. The method of claim 4, wherein the nitric oxide gas leaving the heap is oxidised by oxygen contained in the air being added to the heap to form nitrogen dioxide (NO₂).

7. The method of claim 6, wherein additional air or oxygen, or oxygen enriched air is injected during a scrubbing process to ensure the total oxidation of the nitric oxide gas thereby to generate nitrogen dioxide (NO₂).

8. The method of claim 7, wherein the generated nitrogen dioxide is reacted with a scrubber solution to produce a scrubber effluent.

9. The method of claim 8, further comprising adding an oxidant to the scrubber solution to oxidise any unreacted nitric oxide gas.

10. The method of claim 1, wherein the crushed ore subject to acid agglomeration is agglomerated with acid only, without nitrate addition, to increase the porosity of the ore.

11. The method of claim 1, wherein the nitrate concentration is in the range of 30 g/L to 50 g/L.

12. The method of claim 1, wherein air, oxygen, or oxygen enriched air is passed into the heap at a base of the heap or at multiple points from the base of the heap to the top of the heap.

13. The method of claim 1, wherein the aeration rate is controlled such that it is in the range of 0.01 Nm³/h·t to 0.005 Nm³/h·t.

14. The method of claim 1, wherein the irrigation rate is in the range of 2.5 L/h·m² to 6 L/h·m².

15. The method of claim 14, wherein the specific mass flowrate of air (Ga in kg/h·m²) to the irrigation rate (Gi in kg/h·m²) is in the range of 0.10 to 0.3.

16. The method of claim 1, further comprising:
f) rinsing the heap with a raffinate or process water to remove excess nitrate; and
g) in a separate leach step, irrigating the heap with a second irrigation solution containing an acid nitrate solution.

17. The method of claim 16, wherein the concentration of nitrate in the second irrigation solution is low and is in the range of 0.5 g/L to 15 g/L nitrate.

18. The method of claim 1, wherein the acid concentration in the first irrigation solution and the second irrigation solutions is within the range of 5 g/L to 40 g/L.

19. The method of claim 1, wherein the first irrigation solution in contact with the ore reacts with dissolved iron in the ore to create solution oxidation potentials of 700 mV to 1200 mV SHE (standard hydrogen electrode).

20. The method of claim 19, wherein the heap temperature is increased such that it is in the range of 50° C. to 85° C.

21.-25. (canceled)
